(19) United States
(12) Patent Application Publication
(10) Pub. No.: US 2024/0289525 A1
(43) Pub. Date: Aug. 29, 2024

(54) MACHINE-LEARNING BASED ANOMALY DETECTION SYSTEM FOR VARIOUS PROTOCOL BUS TRANSACTIONS

(71) Applicant: Synopsys, Inc., Mountain View, CA (US)

(72) Inventors: Somasundaram Shanmugasundaram, Coimbatore (IN); Pranay Reddy Chandram, Bangalore (IN); Kavish Seth, Bangalore (IN)

(21) Appl. No.: 18/114,933

(22) Filed: Feb. 27, 2023

(51) Int. Cl. G06F 30/3308; G06F 11/07

(52) U.S. Cl. CPC G06F 30/3308; G06F 11/0751

(57) ABSTRACT

An anomaly detection system including: a primary processing device configured to receive one or more input signals from a simulated system on chip (SoC) circuit electrically coupled to the primary processing device and to classify the one or more input signals based on respective communication protocols of the one or more input signals; and a plurality of secondary processing devices communicatively coupled to the primary processing device, a secondary processing device from among the plurality of secondary processing devices being configured to receive signals from among the classified one or more input signals from the primary processing device, and to determine one or more anomalies in the received signals, the received signals having a communication protocol corresponding to the secondary processing device.

### TECHNICAL FIELD

The present disclosure generally relates to an electronic design automation (EDA) system for development of a system-on-chip (SoC). More specifically, the present disclosure relates to an artificial intelligence (AI)/machine learning (ML) based anomaly detection system to detect anomalies in a design of a system-on-chip (SoC).

### BACKGROUND

System-on-chip (SoC) development may be a technically challenging, tedious, and time-consuming task. Development of an SoC may involve various steps, for example, register transfer level (RTL) design, simulation and verification, RTL synthesis, generating gate level netlist (e.g., a netlist may include the electrical connections between the components on the circuit board and is usually held in a textual format), place and route, timing and physical verification, manufacturing, software integration, and the like.

The above information disclosed in this Background section is only for enhancement of understanding of the background of the invention and therefore it may contain information that does not constitute prior art.

### SUMMARY

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

In one or more embodiments, an anomaly detection system including: a primary processing device configured to receive one or more input signals from a simulated system on chip (SoC) circuit electrically coupled to the primary processing device and to classify the one or more input signals based on respective communication protocols of the one or more input signals; and a plurality of secondary processing devices communicatively coupled to the primary processing device, a secondary processing device from among the plurality of secondary processing devices being configured to receive signals from among the classified one or more input signals from the primary processing device, and to determine one or more anomalies in the received signals, the received signals having a communication protocol corresponding to the secondary processing device.

In one or more embodiments, the communication protocols comprise an Advanced extensible Interface (AXI4) protocol, a Peripheral Component Interconnect Express (PCIe) protocol, a Display Serial Interface (DSI) Physical Layer (PHY) (DPHY) protocol, an Advanced Peripheral Bus (APB) protocol, a Universal Serial Bus (USB) protocol, an embedded Multi-Media Card (eMMC) protocol, and a Universal Asynchronous Receiver/Transmitter (UART) protocol.

In one or more embodiments, the primary processing device is configured to select the secondary processing device from among the plurality of secondary processing devices based on one or more characteristics of the secondary processing device.

In one or more embodiments, the primary processing device comprises one or more artificial neural networks (ANNs) to perform the classification of the one or more input signals based on the respective communication protocols of the one or more input signals.

In one or more embodiments, the one or more ANNs of the primary processing device comprise a multi-layer perceptron neural network configured to classify the one or more input signals based on the respective communication protocols and to assign the secondary processing device from among the plurality of secondary processing devices to detect anomalies.

In one or more embodiments, each of the plurality of secondary processing devices comprises one or more artificial neural networks (ANNs) configured to determine the one or more anomalies in the received signals having the communication protocol corresponding to the secondary processing device.

In one or more embodiments, a structure of the one or more ANNs, in each of the plurality of secondary processing devices is based on the communication protocol of the received signals.

In one or more embodiments, the primary processing device is further configured to receive results of the determining the one or more anomalies from each of the plurality of secondary processing devices and to generate a report comprising the results.

In one or more embodiments, the secondary processing device is further configured to determine a time of occurrence of the one or more anomalies in the one or more input signals having the communication protocol corresponding to the secondary processing device and to provide suggestions to fix the one or more anomalies.

In one or more embodiments, a method including: receiving, at a primary processing device, one or more input signals from a simulated system on a chip (SoC) circuit connected to the primary processing device; classifying, by the primary processing device, the one or more input signals based on respective communication protocols of the one or more input signals; and receiving, by a secondary processing device from among a plurality of secondary processing devices communicatively couple to the primary processing device, signals from among the classified one or more input signals from the primary processing device, the received signals having a communication protocol corresponding to the secondary processing device; and determining, by the secondary processing device, one or more anomalies in the received signals.

In one or more embodiments, the determining the one or more anomalies further includes: separating, by the secondary processing device, read channel signals and write channel signals from among the received signals having the communication protocol corresponding to the secondary processing device; verifying, by the secondary processing device, one or more signals from among the read channel signals; normalizing, by the secondary processing device, the verified one or more signals from among the read channel signals; and determining, by the secondary processing device, one or more anomalies in the one or more signals from among the read channel signals.

In one or more embodiments, the one or more anomalies in the one or more signals from among the read channel signals are determined by one or more artificial neural networks (ANNs) of the secondary processing device, wherein the one or more signals from among the read channel signals comprise read address signals, and wherein the determining the one or more anomalies further includes: processing, by the one or more ANNs of the secondary processing device, the read address signals; determining, by the one or more ANNs of the secondary processing device, an error threshold based on an output of the processing the read address signals; and determining, by the one or more ANNs of the secondary processing device, one or more anomalies in the read address signals based on the error threshold.

In one or more embodiments, the method further includes: generating, by the secondary processing device, a predicted value of read data signals from among the read channel signals; comparing, by the secondary processing device, the predicted value of the read data signals with actual values of the read data signals from the received signals having the communication protocol corresponding to the secondary processing device; and determining, by the secondary processing device, one or more anomalies in the read data signals based on a result of the comparing the predicted value of the read data signals with the actual values of the read data signals. In one or more embodiments, the method further includes: analyzing, by the secondary processing device, B-response signals from among the write channel signals; determining, by the secondary processing device, one or more anomalies in the write channel signals based on a result of analyzing the B-response signals; and displaying, by a display screen coupled to the secondary processing device, a time of occurrence of the one or more anomalies and suggestions to fix the one or more anomalies.

In one or more embodiments, the one or more signals from among the write channel signals comprise write address signals, and wherein the determining the one or more anomalies in the write channel signals further includes: processing, by one or more artificial neural networks (ANNs) of the secondary processing device, the write address signals; determining, by the one or more ANNs of the secondary processing device, an error threshold based on an output of the processing the write address signals; and determining, by the one or more ANNs of the secondary processing device, one or more anomalies in the write address signals based on the error threshold.

In one or more embodiments, the method further includes: generating, by the secondary processing device, write data signals using the write address signals; comparing, by the secondary processing device, the generated write data signals with actual write data signals from the one or more input signals having the communication protocol corresponding to the secondary processing device; and determining, by the secondary processing device, one or more anomalies in the write data signals based on a result of the comparing the generated write data signals with the actual write data signals.

In one or more embodiments, a non-transitory computer readable medium comprising stored instructions, which when executed by a processor, cause the processor to: receive one or more input signals from a simulated system on a chip (SoC) circuit connected to the processor; classify, using a multi-layer perceptron neural network of the processor, the one or more input signals based on respective communication protocols of the one or more input signals; and determine, using an artificial neural network (ANN) from among a plurality of ANNs of the processor, one or more anomalies in the one or more input signals corresponding to a communication protocol of the ANN, based on an error threshold.

In one or more embodiments, the processor is further configured to: separate read channel signals and write channel signals from among the one or more input signals corresponding to the communication protocol of the ANN; verify one or more signals from among the read channel signals; normalize the verified one or more signals from among the read channel signals; and determine one or more anomalies in the one or more signals from among the read channel signals.

In one or more embodiments, the one or more signals from among the read channel signals comprise read address signals, and wherein to determine the one or more anomalies, the processor is further configured to: process the read address signals; determine the error threshold based on an output of the processing the read address signals; and determine one or more anomalies in the read address signals based on the error threshold.

In one or more embodiments, the processor is further configured to: generate a predicted value of read data signals from among the read channel signals; compare the predicted value of the read data signals with actual values of the read data signals from the one or more input signals corresponding to the respective communication protocols of the one or more input signals; and determine one or more anomalies in the read data signals based on a result of the comparison between the predicted value of the read data signals with the actual values of the read data signals.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a block diagram of an example system on chip (SoC), according to one or more embodiments of the present disclosure.

FIG. 2 illustrates the signals of the SoC of FIG. 1, according to one or more embodiments of the present disclosure.

FIG. 3 illustrates a schematic representation of the SoC of FIG. 1 being used in simulation and emulation, according to one or more embodiments of the present disclosure.

FIG. 4 illustrates an example anomaly detection system, according to one or more embodiments of the present disclosure.

FIG. 5A illustrates an example artificial neural network (ANN), according to one or more embodiments of the present disclosure.

FIG. 5B illustrates an example table containing one or more parameters of the ANN of FIG. 5A, according to one or more embodiments of the present disclosure.

FIG. 5C illustrates a table showing an example dataset that may be used to train the ANN of FIG. 5A, according to one or more embodiments of the present disclosure.

FIG. 5D illustrates two graphs, where the graph (A) shows training and validation loss values and graph (B) shows the training and validation accuracy values of the ANN of FIG. 5A, according to one or more embodiments of the present disclosure.

FIG. 5E illustrates a table including a dataset with anomalies infused in an AXI read bus or AXI signals of the SoC of FIG. 1.

FIG. 5F illustrates the mean absolute error (MAE) values of the ANN of FIG. 5A with the anomaly dataset of FIG. 5E, according to one or more embodiments of the present disclosure.

FIG. 5G illustrates a confusion matrix and a F1-score while using the anomaly dataset of FIG. 5E, according to one or more embodiments of the present disclosure.

FIG. 5H illustrates an example ANN, according to one or more embodiments of the present disclosure.

FIG. 5I illustrates two graphs, where the graph (A) shows training and validation loss values for the ANN of FIG. 5H and graph (B) shows the training and validation accuracy values for the ANN of FIG. 5H, according to one or more embodiments of the present disclosure.

FIG. 6A illustrates an example construction and working of an anomaly detection block (ADB), according to one or more embodiments of the present disclosure.

FIG. 6B illustrates in more details the read address request signal and the read data response signal in the ADB of FIG. 6A, according to one or more embodiments of the present disclosure.

FIG. 7A illustrates a flow diagram for anomaly detection in the read channel signals, according to one or more embodiments of the present disclosure.

FIG. 7B illustrates a flow diagram for anomaly detection in the write channel signals, according to one or more embodiments of the present disclosure.

FIG. 8 depicts a flowchart of various processes used during the design and manufacture of an integrated circuit in accordance with some embodiments of the present disclosure.

FIG. 9 depicts a diagram of an example emulation system in accordance with some embodiments of the present disclosure.

FIG. 10 depicts a diagram of an example computer system in which embodiments of the present disclosure may operate

### DETAILED DESCRIPTION

Aspects of the present disclosure relate to a machine learning (ML) based anomaly detection system for various protocol bus transactions during a system on chip (SoC) development.

An SoC is an integrated circuit (IC) that takes a single platform and integrates an entire electronic or computer system onto it. In other words, an SoC is essentially an entire system on a single chip. The components that are incorporated in an SoC may be a central processing unit (CPU), input and output ports, internal memory, as well as analog input and output blocks among other things. Depending on the kind of system that has been reduced to the size of a chip, the SoC can perform a variety of functions including signal processing, wireless communication, AI computation acceleration, and more.

SoC development can be a technically challenging, tedious, and time-consuming task. Development of an SoC may involve various steps, for example, register transfer level (RTL) design, simulation and verification, RTL synthesis, generating gate level netlist (e.g., a netlist may include the electrical connections between the components on the circuit board and is usually held in a textual format), place and route, timing and physical verification, manufacturing, software integration, and the like. Each step in the development process of an SoC may be critical and may have unique challenges.

For example, during the simulation and verification stage of an SoC development, the RTL design code is simulated, and the functionality of different intellectual properties (IPs) integrated on the SoC is tested. An intellectual property (IP) core in semiconductors is a reusable unit of logic or functionality or a cell or a layout design that is developed with the idea of licensing to multiple vendor for using as building blocks in different chip designs.

The testing of the SoC may include millions of read and write transactions using different protocols according to the IPs communicating with a processing device (e.g., a CPU) within the SoC during the testing phase of the SoC. Anomalies or failures during these very large number of read and write transactions in the testing phase is a common issue. An anomaly may be defined as unexpected events, observations, or items that differ significantly from the norm. In one or more embodiments of the present disclosure, an anomaly may be defined as signals that violate the protocol specifications. However, it is very difficult to identify the anomalies from these transactions during the testing phases of the SoC.

One or more embodiments of the present disclosure provide an AI/ML based system, which can take these transactions as input data and can automatically identify the time of occurrence of a failure or anomaly with respect to a communication protocol between components of an SoC. The AI/ML based anomaly detection system of the present disclosure can be used to identify violations or anomalies across various protocols that are used in the SoC.

For example, an AI/ML based anomaly detection system of the present disclosure may identify anomalies across all the transactions happening during the SoC development. In some implementations, an anomaly detection system according to the present disclosure identifies anomalies in the Advanced extensible Interface (AXI) protocol with nearly 100% accuracy, and approaches according to the present disclosure are applicable to other protocols. An anomaly detection system according to the present disclosure aids the SoC development process by identifying problematic or anomalous transactions from among millions of transactions, thereby alerting developers of the SoC to potential errors in the design. Therefore, anomaly detection systems of the present disclosure significantly reduce the SoC verification and development time and effort.

Technical advantages of the AI/ML based anomaly detection system of the present disclosure include, but are not limited to, classifying the SoC signals as an anomaly or positive or correct signal (e.g., a signal with no anomaly), identifying the time of occurrence of failure or anomaly across all the buses in the SoC during both simulation and emulation phases, pointing to the signals in the SoC that may be causing the anomalies and providing suggestions to correct the issues, and enabling the detection of rare anomalies among, for example, millions of transactions.

The AI/ML based anomaly detection system of the present disclosure may be adopted for many different signal communication protocols, for example, AXI4, Peripheral Component Interconnect Express (PCIe), Display Serial Interface (DSI) Physical Layer (PHY) (DPHY), Advanced Peripheral Bus (APB), Universal Serial Bus (USB), embedded Multi-Media Card (eMMC), Universal Asynchronous Receiver/Transmitter (UART), etc. The AI/ML based anomaly detection system of the present disclosure may be light weight (e.g., less utilization of memory, storage or communication bandwidth), fast, and relatively easily trainable on standard processors (e.g., general purpose processors) without any special requirement (e.g., can be extended to other processors and protocol's as well) of specialized processors (e.g., graphics processing units or GPUs or artificial intelligence accelerators) for training. In some embodiments, an ANN may have over millions of trainable parameters. ANN models with few thousands of parameters are considered as light weight models. For example, the AI/ML based anomaly detection system of the present disclosure is designed to be light weight so it can be fast and easy to train. For example, one or more embodiments of the present disclosure may reduce the SoC development time by automatically identifying an anomaly in the system.

The AI/ML based anomaly detection system of the present disclosure may help a user (e.g., an engineer, and a developer) to identify anomalies even with millions of transactions across different buses, debug, and fix the issue quickly, without requiring the user to have domain or protocol expertise in every protocol.

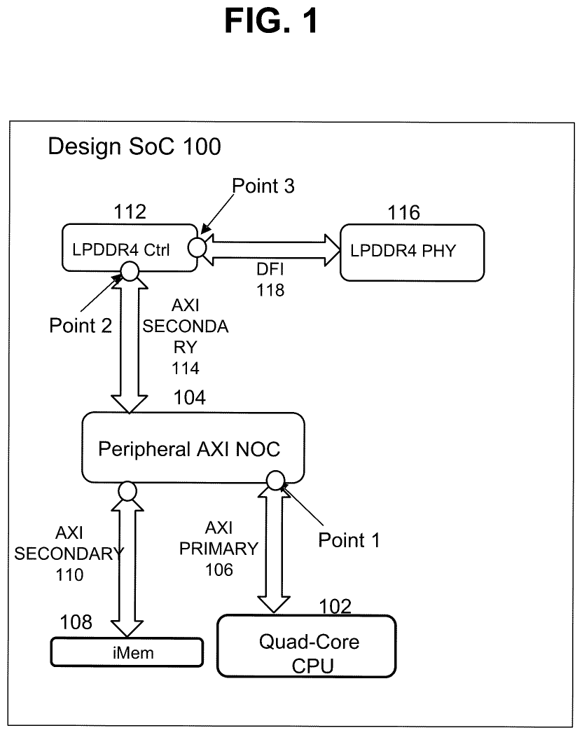

FIG. 1 illustrates a block diagram of an example SoC, according to one or more embodiments of the present disclosure. The SoC 100 of FIG. 1 may be used for testing an AI/ML based anomaly detection system discussed later in the present disclosure.

In one or more embodiments, the SoC 100 includes of a Quad-Core CPU 102 communicatively coupled to a peripheral AXI network on chip (NOC) 104 via an AXI primary connector 106, an internal memory (iMem) 108 communicatively coupled to the peripheral NOC 104 via an AXI secondary connector 110, and a low-power double data rate (LPDDR4) controller 112 communicatively coupled to the peripheral NOC 104 via an AXI secondary connector 114. The SoC 100 further includes a LPDDR4 physical (PHY) module 116 (e.g., circuitry) communicatively coupled with the LPDDR4 controller 112 via a DFI connector 118.

In one or more embodiments, LPDDR4 PHY module 116 may be a physical (PHY) layer IP interface solution for ASICs, ASSPs, SoCs and system-in-package applications requiring high-performance LPDDR4, LPDDR3, DDR4, DDR3, and/or DDR3L SDRAM interfaces operating at up to 4,267 Mbps. In one or more embodiments of the present disclosure, AXI may be an interface specification that defines the interface of IP blocks, rather than the interconnect itself. In one or more embodiments, the DDR PHY interface (DFI) may be an interface protocol that defines signals, timing, and programmable parameters required to transfer control information and data to and from the DRAM devices, and between micro controller (MC) and PHY. DFI is applicable to all dynamic random access memory (DRAM) protocols including DDR4, DDR3, DDR2, DDR, LPDDR4, LPDDR3, LPDDR2 and LPDDR and may be used in several consumer electronics devices including smart phones.

In one or more embodiments, the SoC 100 may include various different IPs in addition to the IP blocks peripheral NOC 104, iMem 108, LPDDR4 controller 112, and the LPDDR4 PHY module 116, as shown in FIG. 1. In some other embodiments, in the SoC 100, one or more IP blocks from among the peripheral NOC 104, iMem 108, LPDDR4 controller 112, and the LPDDR4 PHY module 116 may be removed as well.

As illustrated in FIG. 1, traffic is generated across the SoC 100, and the signals may be probed at different locations of the SoC 100 (e.g., point 1, point 2, and point 3). For example, at point 1 signals from the CPU 102 to the peripheral NOC 104 are probed and analyzed, at point 2 signals from the peripheral NOC 104 to the LPDDR4 controller 112 are probed and analyzed, and at point 3 signals from the LPDDR4 PHY module 116 to the LPDDR4 controller 112 are probed and analyzed. These signals are used to train and test an AI/ML anomaly detection system discussed later.

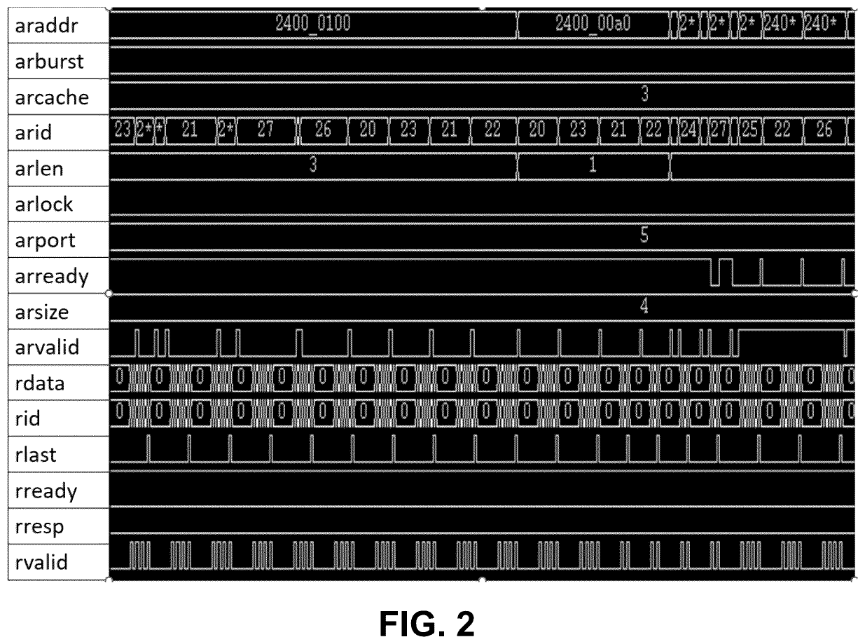

FIG. 2 illustrates the signals at point 1 of the SoC 100 of FIG. 1, according to one or more embodiments of the present disclosure. For example, FIG. 2 illustrates a sample snippet of the AXI read address and read data signals at point 1 of the SoC 100 of FIG. 1. For example, AXI read address and read data signals at point 1 of the SoC 100 may include a plurality of signals, for example, “araddr”, “arburst”, “arcache”, “arid”, and the like.

Any deviation from a desired communication protocol is considered as an anomaly. During the SoC development process, IP modules (e.g., the peripheral NOC 104, iMem 108, LPDDR4 controller 112, and the LPDDR4 PHY module 116) may be integrated into the design of the SoC and then the communication between the IPs and the CPU may be checked for anomalies. During this verification process (e.g., simulation or emulation), memory locations may be accessed to write data and the data that were written were read back from those memory locations to check the functionality of the IP blocks and detect any anomaly in the communication to or from the IP circuit blocks.

However, anomalies occur in different forms which, in some cases, may be difficult to identify. For example, if during the testing phase of the SoC, the IP is unable to read the data from any of the provided address, which may be identified as an anomaly. For example, when a read address command is provided at an IP, the IP is supposed to read the data present in the address. If the data in the address that is provided to the IP is not available in the signal waveform at the output of the IP, that signal may be debugged further to understand the issue and detect if there is any anomaly present in the IP.

In one or more embodiments, the input signal sent to the IP may contain anomalies. For example, when the IP is trying to read a 128 bit data, the maximum value provided to an “arsize[2:0]” bus that may be connected to an input of the IP, should not be more than 4. However, an “arsize[2:0]” bus can carry values from 0 to 7 (because the arsize[2:0] bus is three bits wide). Providing any value between 5 and 7 to an “arsize[2:0]” bus that is connected to an input of the IP may lead mismatch in the size of the data and may generate an anomaly.

In one or more embodiments, not providing a valid input read address to an IP to fetch or read the data in that address may lead to generation of anomalies. In some other embodiments, when an IP is trying to read a 128-bit data, the channel that is connected between the IP and the memory may only be able to deliver 64-bit data to the IP, while missing the remaining 64-bit data. This may lead to generation of anomalies.

The above anomalies may be a few examples of the anomalies that may be generated during the verification process of designing the SoC. However, any violation of protocols during the transaction between the IP modules in the SoC may also be considered as an anomaly. For example, absence of “rlast” signal during the last beat of an AXI read address and read data signals shown in FIG. 2 may be considered as an anomaly in the AXI read address and read data signals at point 1 of the SoC 100 of FIG. 1. As another example, mismatch in the “arid” values during a sequence of transactions in the AXI read address and read data signals at point 1 of the SoC 100 of FIG. 1 may also be considered as an anomaly. Further, in some cases, an absence of “rvalid” signal in the AXI read address and read data signals at point 1 of the SoC 100 of FIG. 1 during a valid transaction of the IP module (e.g., the peripheral NOC 104) may also be considered as an anomaly. Further, a mismatch in “arlen” value signal in the AXI read address and read data signals at point 1 of the SoC 100 of FIG. 1 during a read address performed by the IP and the number of bits received in the read data bus may be considered as an anomaly.

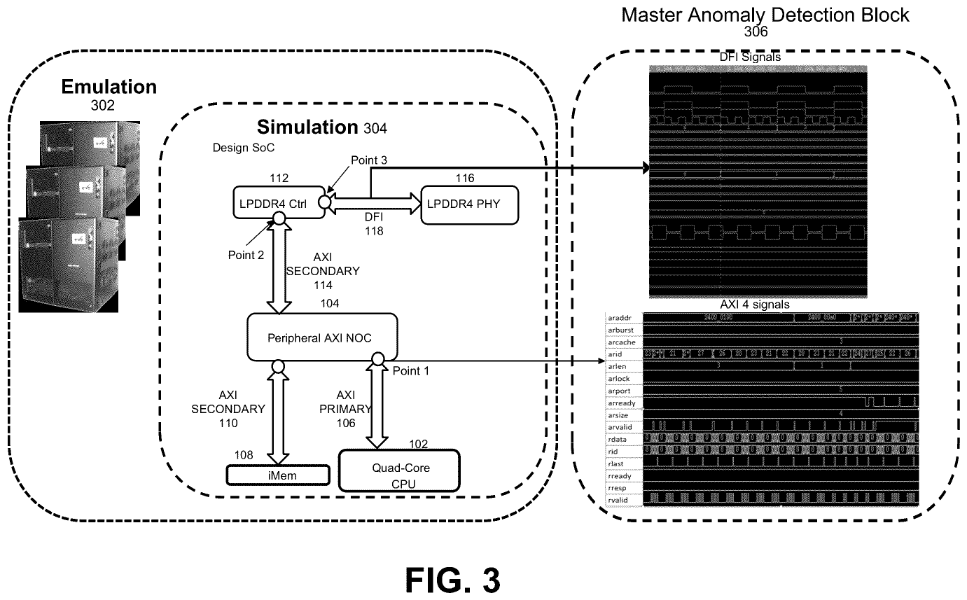

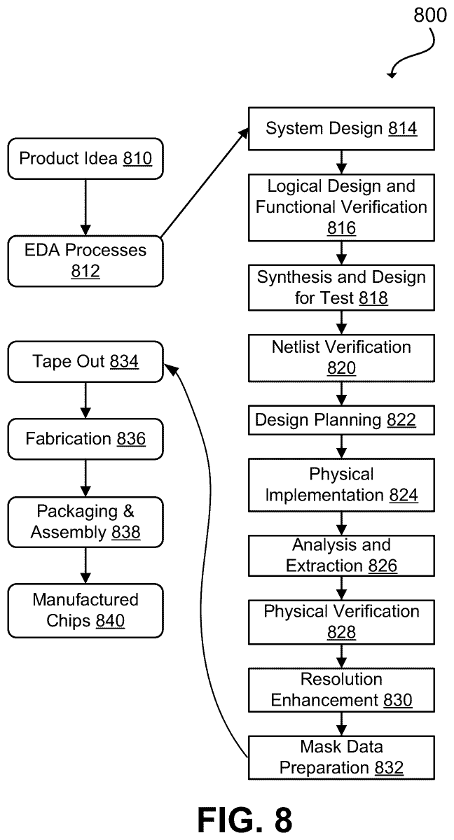

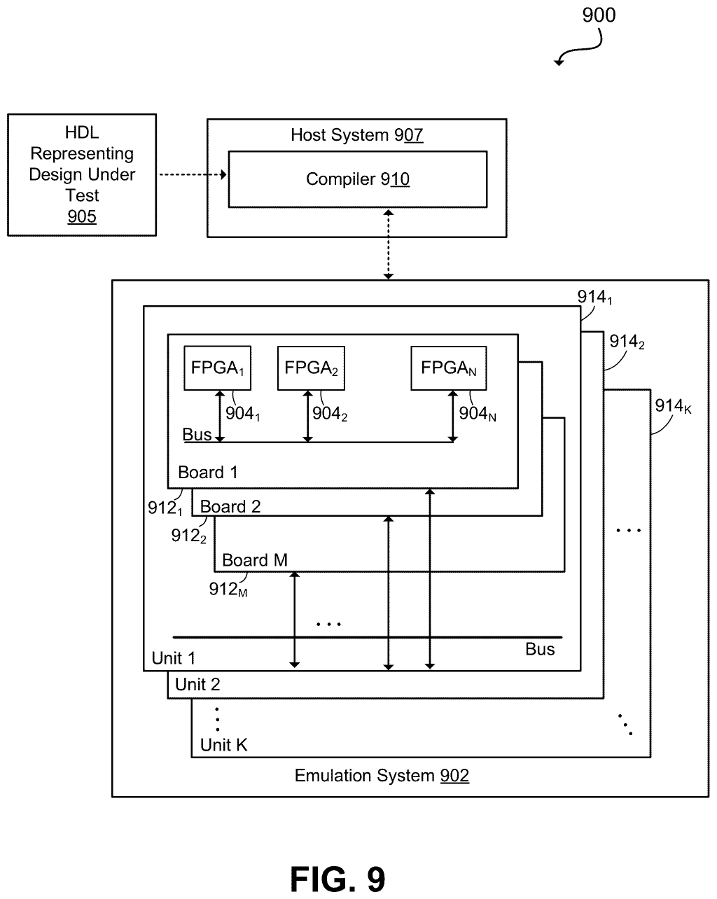

FIG. 3 illustrates a schematic representation of the SoC 100 of FIG. 1 being used in simulation 304 and emulation 302, according to one or more embodiments of the present disclosure. Simulation and emulation are discussed in detail with respect to FIGS. 8 and 9 of the present disclosure. The signals are probed at different locations and transmitted to a primary anomaly detection block (PADB) 306 (e.g., a primary processing device). For example, at point 1, AXI signals from the CPU 102 to the peripheral NOC 104 are probed and transmitted to the PADB 306, and at point 3, DFI signals from the LPDDR4 PHY module 116 to the LPDDR4 controller 112 are probed and transmitted to the PADB 306. These signals are used to train and test the PADB 306.

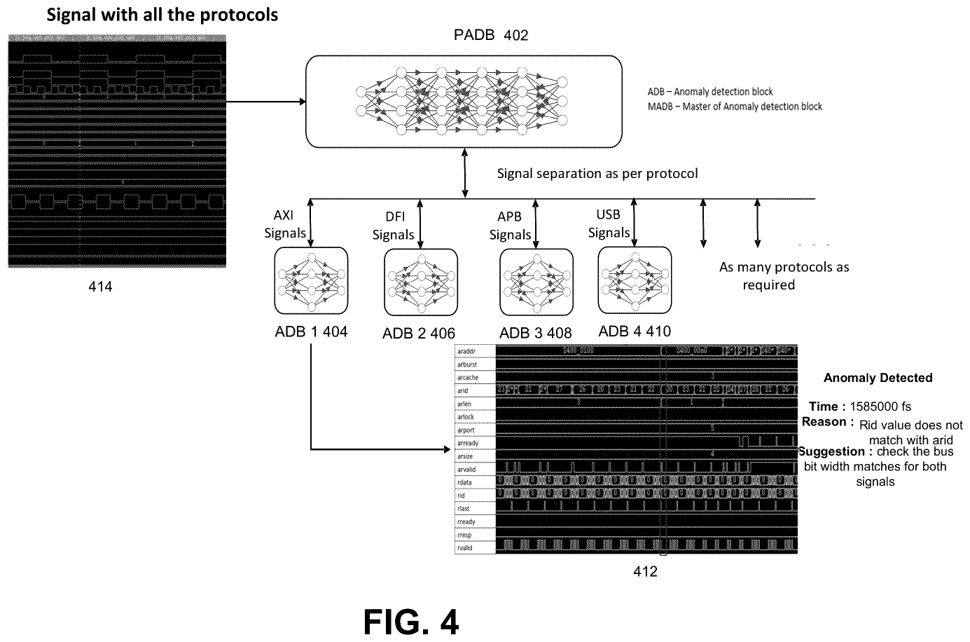

FIG. 4 illustrates an example anomaly detection system, according to one or more embodiments of the present disclosure. The anomaly detection system 400 of FIG. 4 may include a PADB 402 (e.g., a primary processing device), and a plurality of anomaly detection blocks (ADB) (e.g., a plurality of secondary processing devices), for example, ADB1 404, ADB2 406, ADB3 408, ADB4 410, and the like, communicatively coupled to the PADB 402 via their respective protocol buses. The PADB 402 may be the same as the PADB 306 of FIG. 3. In one or more embodiments, the PADB 402 and/or the plurality of ADBs may be implemented by processing devices (e.g., a central processing unit (CPU), a graphics processing unit (GPU), a field programmable gate array (FPGA), or the like) executing instructions or by hardware circuitry. For example, the ANNs in the PADB 402 and/or the plurality of ADBs may be implemented using complementary metal-oxide semiconductor (CMOS) digital circuits, which have the advantage of being easy to design and build. They rely on existing logic elements and can take full advantage of decades of advances in digital circuits. In some cases, the ANNs in the PADB 402 and/or the plurality of ADBs may also be implemented using analog circuits. In one or more embodiments, the ADB's (e.g., 404, 406, 408, 410) and the PADB 402 may be implemented as one or more software applications running on a general purpose CPU.

In some circumstances, SoC (e.g., SoC 100) development includes multiple stages of verification. The SoC (e.g., SoC 100) under development is simulated using a simulation system. After simulation, the design is compiled to generate a bit file (or multiple bit files) which is used to program field programmable gate arrays (FPGAs) to test the circuit design on an emulation system. As anomalies are common in both the simulation and emulation phases of testing, the anomaly detection system 400 according to embodiments of the present disclosure can be used during both the phases. The signals that are tested may be probed at desired locations, such as, point 1, point 2, point 3, as shown in FIG. 3 are passed on to the PADB 402. The PADB 402 may read all the signals input to the PADB 402 and separate the signals as per the protocol. These separated signals are further transferred to the ADB1 404, ADB2 406, ADB3 408, ADB4 410, and the like, based on their respective signal protocols.

In one or more embodiments, the PADB 402 may include one or more artificial neural networks (ANNs) to perform the classification of the signals received from the SoC design under test (e.g., SoC 100). The characteristics (e.g., hyperparameters) of the ANNs (e.g., number of input and/or output nodes of the ANN, number of hidden layers of the ANN, weight values of the ANNs) in an PADB 402 and the number of ANNs in the PADB 402 may vary depending on the signals received from the SoC design under test (e.g., SoC 100) and the type of signal communication protocols in the SoC under test (e.g., SoC 100). For example, in one or more embodiments, the characteristics of the ADBs (e.g., 404, 406, 408, 410) and the PADB 402 may be changed based on the input signal protocol. For example, the ANNs in the ADBs (e.g., 404, 406, 408, 410) and the PADB 402 may have more input layers with more hidden layers for PCIe protocol to detect the anomaly in a PCIe signal. In one or more embodiments, the PADB 402 may include a multi-layer perceptron neural network configured to classify the input signals as per the protocols and assign an ADB from among the ADBs (e.g., ADB1 404, ADB2 406, ADB3 408, ADB4 410, and the like) for each protocol of the input signals received from the SoC, to detect anomalies in the input signals. The PADB 402 is also configured to collect information from the individual ADBs to generate a final report of the detected anomalies in the input signals and display anomalies identified across different protocols.

As such, the PADB 402 may be configured to separate signals as per their protocols, communicate with different ADB's, distribute anomaly detection tasks to the ADBs based on the classifications of the signals, and collect the result from each of the ADBs as shown in FIG. 4.

For example, the PADB 402 may be configured to receive the signals from the SoC under test (e.g., SoC 100) and classify the received signals based on one or more characteristics of the received signals (e.g., classify the signals based on the signal protocol). Based on the classification of the received signals and the one or more characteristics of the ADBs communicatively coupled to the PADB 402 via respective buses, the PADB 402 may select an ADB from among the ADB1 404, ADB2 406, ADB3 408, ADB4 410, and the like. For example, each ADB may correspond to a different protocol or different portion of a protocol (e.g., transmit versus receive), and therefore the PADB 402 may select an ADB for a particular set of received signals based on the class (or classification) of those received signals.

For example, each of the ADB1 404, ADB2 406, ADB3 408, ADB4 410, and the like, may be designated to detect anomalies in a particular type of signal protocol or a particular class of signal. For example, ADB1 404 may be designated to detect anomalies in AXI signals, ADB2 406 may be designated to detect anomalies in DFI signals, ADB3 408 may be designated to detect anomalies in advanced peripheral bus (APB) signals, and ADB4 410 may be designated to detect anomalies in universal serial bus (USB) signals from the SoC under test (e.g., the SoC 100 of FIG. 1). Depending on the number of signals that are analyzed to test the different IP blocks of an SoC under test (e.g., SoC 100 of FIG. 1), the anomaly detection system 400 may include various different ADBs for anomaly detection in different signal protocols or different class of signals. Once one or more anomalies are detected in the received signals by one or more ADBs from among the ADB1 404, ADB2 406, ADB3 408, ADB4 410, and the like, the PADB 402 may be configured to collect the results of the anomaly detection from the ADBs coupled to the PADB 402 and may generate a report on the status of the overall signals across various buses in the SoC at any given point of time.

In one or more embodiments, each of the ADBs (e.g., the ADB1 404, ADB2 406, ADB3 408, ADB4 410, and the like) may include various configurable or modifiable blocks for separating signals, verifying handshaking process, normalizing the data, fetching data to a Neural Network (NN) of the ADB, calculating error threshold, or the like. In one or more embodiments, there are various predefined blocks that can be readily plugged in or out to create an ADB as per the corresponding protocol. A predefined block may be an IP core. As discussed above, an IP core in semiconductors is a reusable unit of logic or functionality or a cell or a layout design that is developed with the idea of licensing to multiple vendor for using as building blocks in different chip designs.

The anomaly detection system 400 can identify an anomaly in the signals received from the SoC under test (e.g., SoC 100) while read and/or write transactions are happening in any protocol in the SoC under test (e.g., SoC 100) by first classifying the signals by the PADB 402 and then determining whether anomalies are present in each class of signals (e.g., each of the signal protocols) by a respective ADB from among the ADB1 404, ADB2 406, ADB3 408, ADB4 410, and the like. In some embodiments, if the PADB 402 receives a signal for classification that that does not fit into any of the existing ADBs (e.g., 404, 406, 408, 410) or correspond to the protocols of the existing ADBs (e.g., 404, 406, 408, 410), the PADB 402 may identify the signal as an “unidentified signal” and send a notification to the user (e.g., an engineer or a developer designing the system). A new ADB may be designed according to the protocol of the unidentified signal and added to the anomaly detection system 400.

In addition to detecting one or more anomalies in signals from the SoC under test (e.g., SoC 100 of FIG. 1), the anomaly detection system 400 may also provide suggestions to fix the anomaly or debug the issue, which may assist a user in debugging the issue more quickly. For example, if there is a mismatch in “rid” and “arid” values in the AXI signals in a particular time frame, the anomaly detection system 400 may automatically suggest checking the bit width of both the “rid” and “arid signals in the AXI signals. In one or more embodiments, there may be N-number (e.g., N is an integer) of suggestions that may be learned and stored during the training process of the anomaly detection system 400. During the inference, the suggestions are picked from the repository as per the violation (e.g., based on the detected anomaly).

In one or more embodiments, each ADB from among the ADB1 404, ADB2 406, ADB3 408, ADB4 410, and the like, in the anomaly detection system 400 may include one or more artificial neural networks (ANN) depending on the protocol bus connected to the ADB. These ADB's (e.g., ADB1 404, ADB2 406, ADB3 408, ADB4 410, and the like) are responsible to analyze the signal traffic from the PADB 402 and identify the time at which the anomaly has occurred. The ADBs (e.g., ADB1 404, ADB2 406, ADB3 408, ADB4 410, and the like) also provide the reason for classifying the signal as an anomaly, e.g., by displaying the reason on a user interface. For example, when analyzing the AXI signals from the PADB 402, the ADB1 404 may determine one or more anomalies in the AXI signal that is being analyzed based on a “rid” value in the AXI signals in a particular time frame not matching with the “arid” value of the AXI signals in that particular time frame and/or a “rlast” signal not being present in the AXI signals in a particular time frame.

The structure and characteristics (e.g., the number of input nodes, the number of hidden layers and the numbers of nodes in each hidden layer, the number of output nodes, input features, weights associated with the features of the of the ANNs, etc.) of the ANNs in an ADB and the number of ANNs in the ADB may vary depending on the type of signal communication protocol that is being sent to the ADB for determining the anomalies in that signal. For example, the characteristics of the ANNs in the ADBs and PADB may be determined by the user of anomaly detection system (e.g., the engineer or developer designing the system). After analyzing the protocols of the signals of the SoC, for example, the number of signals, data format etc., the user (e.g., the engineer or developer designing the system) may determine the characteristics of the ANNs in the ADBs and PADB. The user (e.g., the engineer or developer designing the system) may change the characteristics of each of the ANNs in the ADBs and PADB based on a desired output (e.g., what the user intends to accomplish or attain from the anomaly detection system). The user may intend to accomplish better accuracy, may intent to increase the speed of the anomaly detection system to detect the anomalies relatively faster with lesser accuracy, or the like.

In one or more embodiments, ANNs inside each of the ADBs may be designed and trained from scratch to achieve maximum accuracy while detecting anomalies. In one or more embodiments, there may be various pretrained NN blocks readily available (e.g., sequential and recurrent neural networks) for different protocols that can be plugged in or out to create an ADB relatively quickly as per requirements. If a signal is classified as an anomaly, the time of occurrence of anomaly and suggestions to fix the anomaly may be displayed at the anomaly detection block as well.

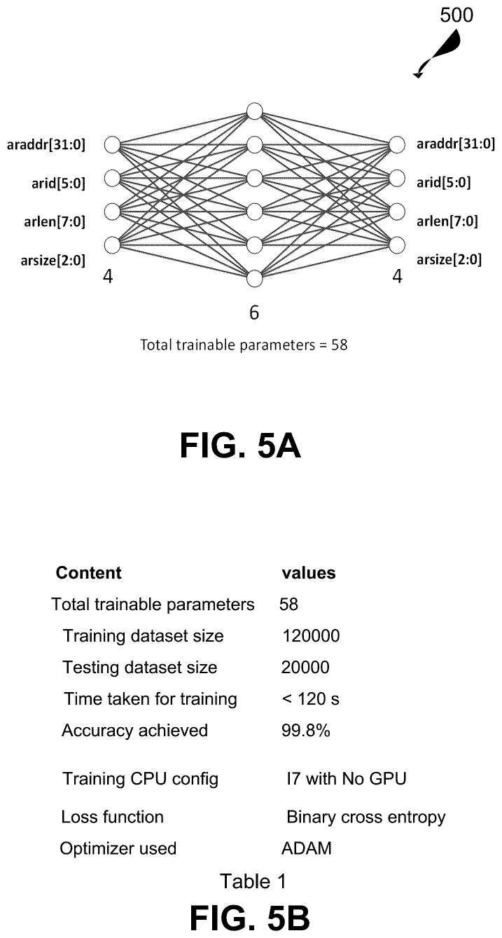

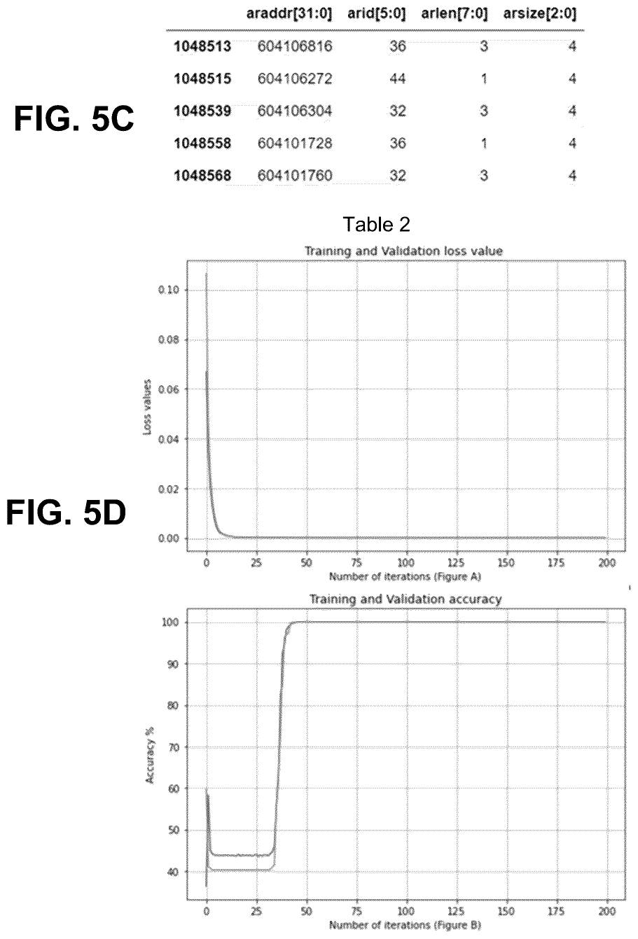

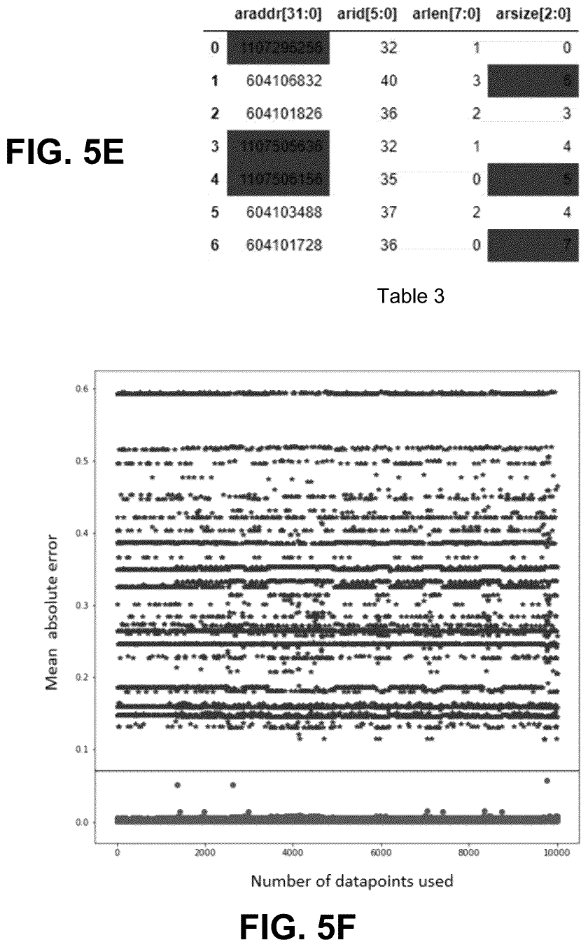

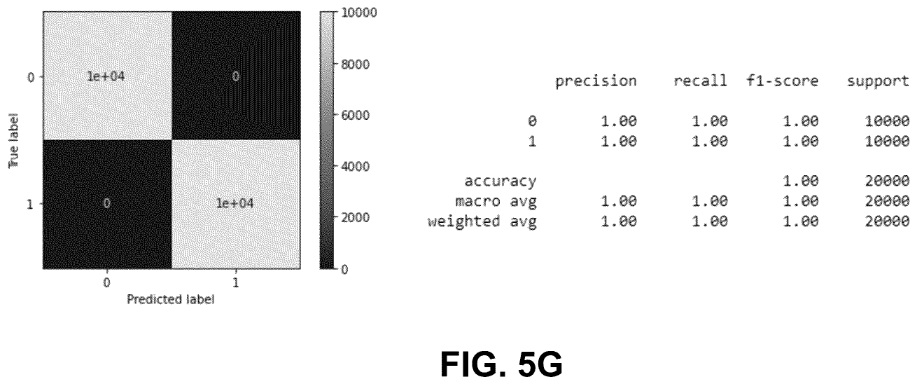

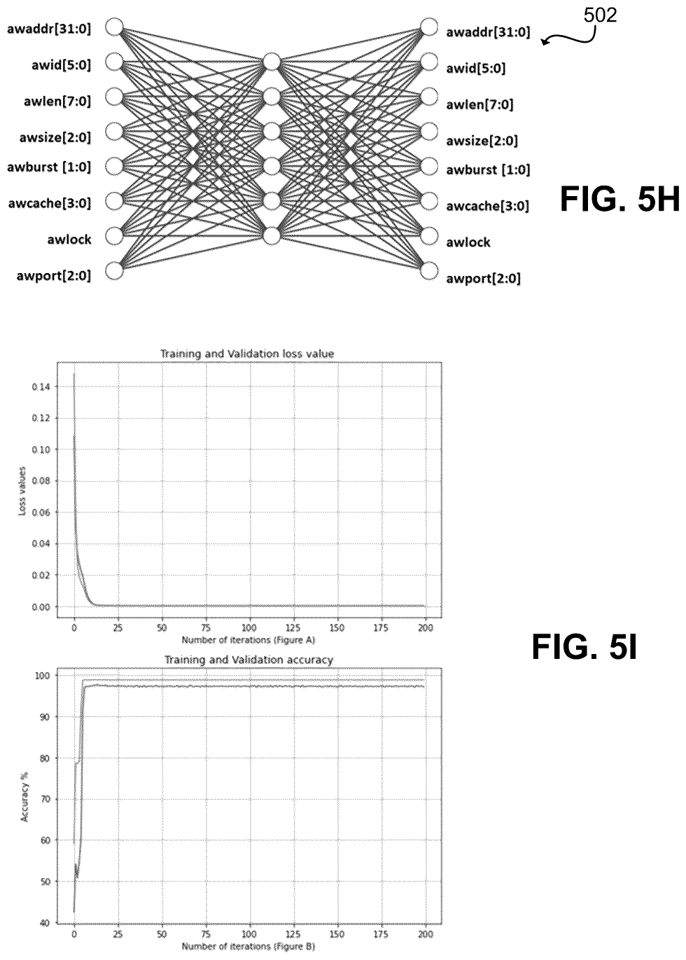

For example, FIG. 5A illustrates an example ANN in an ADB, according to one or more embodiments of the present disclosure. For example, the ANN 500 of FIG. 5A may be an ANN from among one or more ANNs of the ADB1 404 of the anomaly detection system 400 of FIG. 4 and may be used to determine anomalies in the AXI protocol read channel signals. FIG. 5B illustrates an example table (Table 1) including one or more parameters of the ANN 500 of FIG. 5A, according to one or more embodiments of the present disclosure.

The ANN 500 includes four input nodes, one hidden layer with six nodes, and four output nodes. Because the ANN 500 includes four input nodes, one hidden layer with six nodes, and four output nodes, the ANN 500 may include 58 trainable parameters. For example, each of the input nodes and the output nodes has a connection to the hidden layer nodes. In the current embodiment, there are 4 input nodes, 4 output nodes, and 6 hidden nodes that are connected together. As such, there are (4×6=24) connections between the hidden nodes and the input nodes and 24 trainable parameters are between the hidden nodes and the input nodes. Similarly, there are (4×6=24) connections between the hidden nodes and the output nodes and 24 trainable parameters are between the hidden nodes and the output nodes. Further, the hidden layer has 6 bias values and the output has 4 bias values. As such, the ANN 500 may include (24+24+6+4=58) trainable parameters. The number of parameters may vary depending on the number of input and output nodes and the number of input & output nodes depends on the signal protocols.

As the ANN 500 only includes 58 trainable parameters, the ANN 500 may be a relatively light weight and quick ANN to train (e.g., using backpropagation) and light weight and quick to run in inference mode (e.g., using forward propagation) to detect anomalies in input signals. The number of parameters in the ANNs in each ADB and the architecture of the one or more ANNs in each ADB may vary depending on the signal type or the signal protocol the ADB is processing for anomaly detection.

For example, the number of inputs to the ANN 500 may be based on the number of signals from the AXI signals that can sufficiently accurately represent the AXI signals input to the ANN 500 in the ADB1 404. For example, as shown in FIG. 4, in the AXI signals 412 received at the ADB1 404, the signals “araddr”, “arid”, “arlen”, “arsize” may have the greatest number of positive values. Other signals in the AXI signals 412 received at the ADB1 404 may mostly include zero values. Therefore, the signals “araddr”, “arid”, “arlen”, “arsize” sufficiently accurately represent the AXI signals input to the ANN 500 in the ADB1 404 and are input to the ANN 500 in the ADB1 404.

In some embodiments of the present disclosure, the ANN is configured as an autoencoder, where the weight values of the ANN 500 are trained to predict only the input signals (e.g., to encode the input signals into an encoding space, and to reproduce those same input signals at the output). For example, if the ANN 500 is configured as an autoencoder, the essential features or patterns that represent the input data are extracted in the form of weights in the hidden layers to easily identify the positive signals (e.g., signals with no anomalies) and/or negative or anomalous signals. For example, in one or more embodiments, the ANN 500 may perform as an identity function and reproduce the inputs it was given as its output. The anomaly detection is then performed by detecting situations where the produced output does not match the input, in which case the input was anomalous.

While training the ANN 500 model to reduce or minimize the loss with all the positive signals (e.g., signals with no anomalies), the model of the ANN 500 may output a higher loss value for signals with anomalies. By defining a suitable threshold loss value, the input signal (e.g., the input signal represented by the various input parameters that are input to the ANN 500) can be classified as an anomaly or a positive signal (e.g., signals with no anomalies). In one or more embodiments, the suitable threshold loss value is determined by a data scientist based on the loss values for the anomalous signals and the positive signals (e.g., signals with no anomalies). The suitable threshold loss value may be a middle value or a median value between an anomalous signal loss value and a positive signal loss value.

In one or more embodiments, for training the ANN 500 for anomaly detection, the binary cross entropy loss function may be used. The binary cross entropy loss function may be as follows.

$${H}_{p} ( q ) = - \frac{1}{N} {\sum }_{i = 1}^{N} ( {y}_{i} \cdot log ( p ( {y}_{i} ) ) + ( 1 - {y}_{i} ) \cdot log ( 1 - p ( {y}_{i} ) ) ) \qquad ( 1 )$$

In the above equation (1), y; represents the actual value of the training data (e.g., the training data value after data normalization), p(yᵢ) represents the predicted probability of the true class, and the number of training samples is represented by N. The first term (e.g., (yᵢ·log(p(yᵢ))) in equation (1) represents the entropy of the prediction probabilities of the true class and the second term (e.g., ((1−yᵢ)·log(1−p(yᵢ))) in equation (1) represents the entropy of the negative class. The training objective is to maximize the classification accuracy by minimizing the binary cross entropy loss.

As shown in FIG. 5B, an optimizer (e.g., an Adam optimizer, a Root Mean Square propagation (RMS Prop), Adaptive Gradient Algorithm (Adagrad), Stochastic & Batch Gradient Descent Algorithms, and the like) may be used to train the ANN 500. Adam is an optimization algorithm that may be used other than the classical stochastic gradient descent procedure to update network weights iteratively based on training data. The equations based on which the Adam optimizer may perform the training of the ANN 500 may be as follows.

$${m}_{t} = {β}_{1} {m}_{t - 1} + ( 1 - {β}_{1} ) {g}_{t} \qquad ( 2 )$$

$${v}_{t} = {β}_{2} {v}_{t - 1} + ( 1 - {β}_{2} ) {g}_{t}^{2} \qquad ( 3 )$$

$${w}_{t} = {w}_{t - 1} - η \frac{\sqrt{+ ε}}{} \qquad ( 4 )$$

In the above equations (2)-(4), gₜ may represent a gradient, β₁ and β₂ may represent hyperparameters, mₜ and vₜ may represent moving averages based on which an updated weight wₜ may be calculated, η may represent a step size, and ε may be a very small number to prevent division by zero error (e.g., 10 e-8). Other optimization algorithms, such as, Momentum, Nesterov Accelerated Gradient (NAG), Adagrad, AdaDelta, or the like may also be used in combination with or instead of Adam optimization in one or more embodiments of the present disclosure.

FIG. 5C illustrates a table (e.g., “Table 2”) showing a snippet of an example dataset that may be used to train the ANN 500 and FIG. 5D illustrates two graphs, where the graph (A) shows training and validation loss values of the ANN 500 of FIG. 5A and graph (B) shows the training and validation accuracy values of the ANN 500 of FIG. 5A, according to one or more embodiments of the present disclosure. For example, in FIG. 5C, “araddr” corresponds to an address of the first transfer in a read transaction, “arid” is an identification tag for a read transaction, “arlen” represents length (e.g., the exact number of data transfers in a read transaction), “arsize” represents size (e.g., the number of bytes in each data transfer in a read transaction, and “1048513” is the time of occurrence of hand shaking.

The example dataset of FIG. 5C includes four signals corresponding to read address as, “araddr[31:0]”, “arid[5:0]”, “arlen[7:0]” and “arsize[2:0]” from among the AXI signals (e.g., AXI signals 412 of FIG. 4). The address values in the “araddr[31:0]” are selected between 0x24000000 to 0x24040000 and converted to decimal values. Because the signals between these address values may corresponds to “iMem” 108 of the SoC 100 (e.g., see FIG. 3), in one or more embodiments, all the signals with these address ranges may be used for training the ANN 500. Rest of the read address channel signals from among the AXI signals (e.g., AXI signals 412 of FIG. 4) may be neglected as all the values remain constant. As shown in FIG. 5B, from the total training dataset, 120000 datapoints may be used for training and 20000 datapoints may be used for testing the trained ANN 500, and it may take less than 120s to train the ANN 500 using the example dataset. One datapoint is one row of data containing four signals as shown the table of FIG. 5C.

In one or more embodiments, the ANN 500 may be trained for 200 epochs with a batch size of 256. As shown in graph (A) of FIG. 5D, the training and validation loss value may be 1.94e-5 and 1.34e-5 respectively at the end of the training. Further, as shown in graph (B) of FIG. 5D, the ANN 500 may be trained using the dataset shown in FIG. 5C to achieve a training and validation accuracy of both 99.8%.

FIG. 5E illustrates a table (“Table 3”) including a snippet of a dataset with anomalies infused in AXI read bus or AXI signals of the SoC 100.

Because in the current embodiment, it is assumed that the ANN 500 has been trained only with the positive datapoints, a separate dataset may be created by incorporating anomalies into the testing dataset. As discussed above, in the current embodiment, the ANN 500 may be trained with the signals corresponding to “iMem” (e.g., iMem 108 of the SoC 100 of FIG. 3) address range (0X24000000 to 0x24040000) and it may be assumed that the ANN 500 is configured to read data of maximum size of 128 bit. To infuse anomalies, the values of “araddr[31:0]” and “arsize[2:0]” may be altered as shown in FIG. 5E. The anomaly dataset may include 20000 datapoints containing 10000 anomalies and 10000 positive datapoints.

In one or more embodiments, while running the inference on ANN 500 with the anomaly dataset shown in FIG. 5E, the output of the ANN 500 may deviate whenever there is an anomaly. The deviation of the output is calculated using a mean absolute error (MAE) as shown in equation (5).

$$MAE = \frac{{\sum }_{i = 1}^{n} \vert {y}_{i} - {x}_{i} \vert}{n} \qquad ( 5 )$$

In equation (5), yᵢ represents the actual value (e.g., the training data value after data normalization) of the training data, xᵢ represents the predicted value of the training data and n represents the number of input/output signals.

FIG. 5F illustrates the MAE values of the ANN 500 with the anomaly dataset of FIG. 5E, according to one or more embodiments of the present disclosure. The circles and the stars are the MAE values obtained by using positive datapoints and anomalies respectively with the ANN 500. From FIG. 5F, it may be observed that all the MAE values of anomaly datapoints are greater than 0.1 whereas it is less than 0.05 for positive datapoints. By defining an error threshold of 0.07, all the positive and negative datapoints can be classified with approximately 100% accuracy. This threshold value may change based on the dataset used for training the ANN in an ADB (e.g., ADB1 404 of FIG. 4) and the testing dataset.

FIG. 5G illustrates a confusion matrix and a F1-score while using the anomaly dataset of FIG. 5E, according to one or more embodiments of the present disclosure. It may be observed from FIG. 5G that there are no false positives and false negatives indicating 100% precision and recall scores for all the 20k datapoints.

FIG. 5H illustrates an example ANN in an ADB, according to one or more embodiments of the present disclosure. FIG. 5I illustrates two graphs, where the graph (A) shows training and validation loss values for the ANN of FIG. 5H and graph (B) shows the training and validation accuracy values for the ANN of FIG. 5H, according to one or more embodiments of the present disclosure.

For example, the ANN 502 of FIG. 5H may be an ANN from among one or more ANNs of the ADB1 404 of the anomaly detection system 400 of FIG. 4 and may be used to determine anomalies in the AXI protocol write channel signals.

The ANN 502 may include eight input nodes, one hidden layer with six nodes, and eight output nodes. Because the ANN 502 includes eight input nodes, one hidden layer with six nodes, and eight output nodes, the ANN 502 may include 110 trainable parameters. The loss function and the optimizer used in training the ANN 502 are mean squared error (MSE) and Adam, respectively, as discussed with respect to the ANN 500. In one or more embodiments, the ANN 502 may be trained for 200 epochs achieving training-validation loss value of 1.95e-4 as shown in graph (A) of FIG. 5I and the training-validation accuracy value of 98% as shown in graph (B) of FIG. 5I.

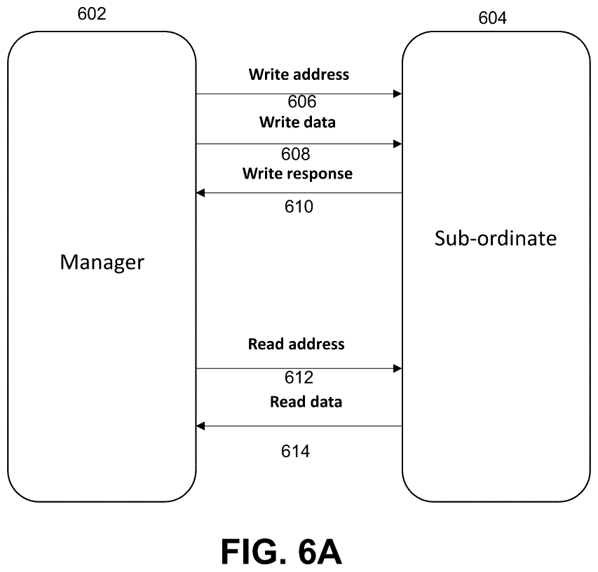

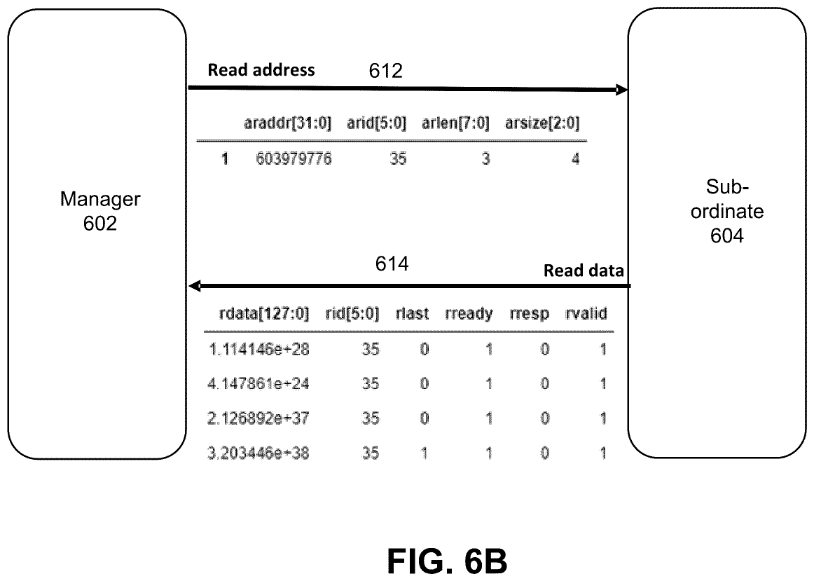

FIG. 6A illustrates an example construction and working of an ADB (e.g., ADB1 404) connected to the AXI bus, according to one or more embodiments of the present disclosure. For example, the ADB (e.g., ADB1 404) may include a manager 602 communicatively coupled to a sub-ordinate via one or more read and/or write channels. For example, the read and/or write channels coupled between the manager 602 and the subordinate 604 may be a write address channel 606, a write data channel 608, a write response channel 610, a read address channel 612, and a read data channel 614. The AXI protocol may include five main channels as shown in FIG. 6A. From among these five main channels, two channels may be designated for read operations and three channels are designated for write operations. Each of the channel may include various signals to assist their respective operations.

FIG. 6B illustrates in more detail the read address request signal in the read address channel 612 from the manager 602 and the read data response signal in the read data channel 614 from the subordinate 604 in the ADB of FIG. 6A, according to one or more embodiments of the present disclosure.

For verifying the read data channel 614, the signals from both the read address channel 612 and the read data channel 614 may be used. FIG. 6B illustrates an example request from the read address channel 612 and the response from read data channel 614. In the example embodiment of FIG. 6B, the read address channel 612 sends the address “araddr[31:0]” from which the data must be read. Along with the address, it also sends the “arid[5:0]”, “arlen[7:0]”, and “arsize[2:0]” signals. As per the AXI protocol, the “arlen[7:0]” signal provides the number of bits expected from the read address channel 612. In the example shown in FIG. 6B, it may be observed that the “arlen[7:0]” value is 3, so there may be four bits (e.g., “arlen”+1) in response to the same “rid[5:0]” values from read data channel 614. It can also be observed “rlast” has a value of 1 in the last transaction of the read data channel. In the example of FIG. 6B, it may be observed that the “arlen[7:0]” value is 3, so there are four bits (e.g., “arlen”+1) in the read data channel. Each row in the bottom table of FIG. 6B with respect to the read data channel 614 corresponds to 1 bit and there are 4 rows as arlen is 3. The arid[5:0] values may not be all the same (e.g., as shown in FIG. 5E, each row has different arid values). Each row of FIG. 5E, according to the arlen values, may generate corresponding rows of “rdata” as shown in FIG. 6B. For example, one row of FIG. 5E, is shown as the top table of FIG. 6B with respect to the read address channel 612.

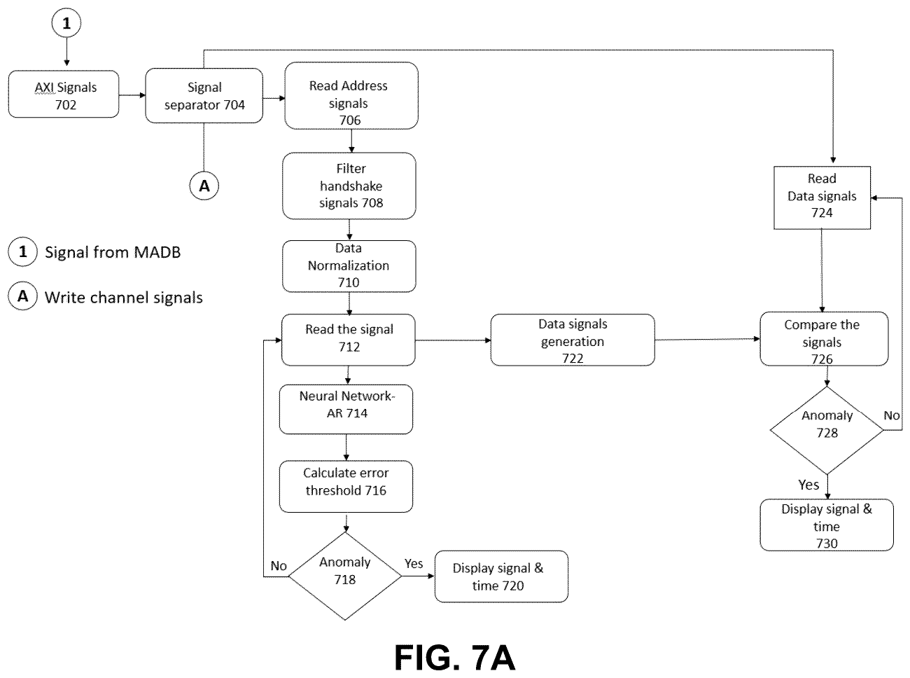

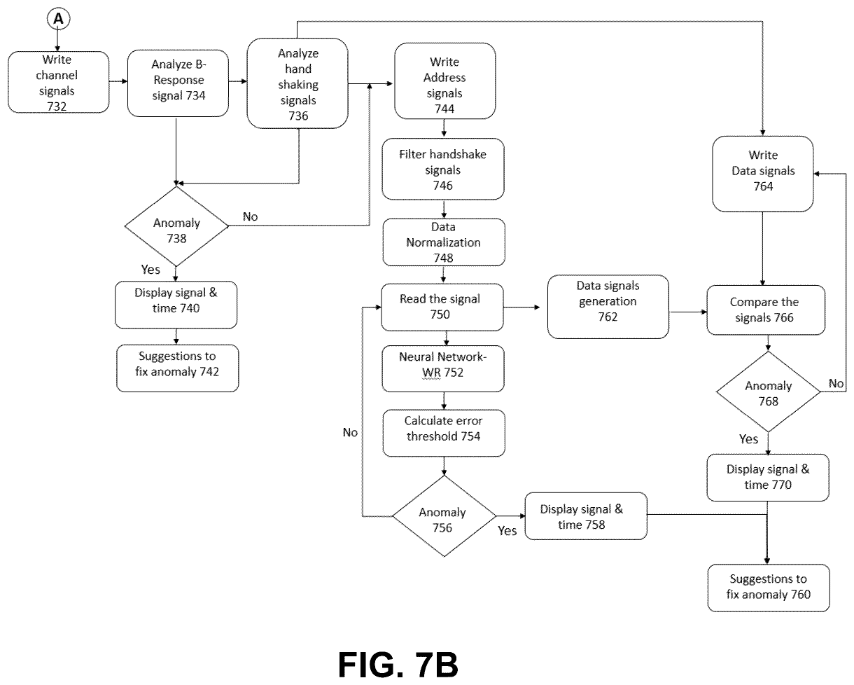

FIG. 7A illustrates a flow diagram for anomaly detection in the read channel signals of the AXI signals, according to one or more embodiments of the present disclosure. This method may be performed by ADB (e.g., ADB1 404).

At 702, the signals from the CPU 102 to the peripheral NOC 104 of the SoC 100 (e.g., the signals 414 of FIG. 4) may be collected at point 1, as shown in FIGS. 3-4. The collected signals from point 1 of the SoC 100 may be passed to the PADB 402 of FIG. 4, which may classify the signal as AXI or DFI or as other protocol signals, and further pass the classified signal to their respective ADB. For example, if the signals collected from point 1 are classified as AXI signals (e.g., AXI signals 412), the signals are passed to the ADB1 404 (e.g., as discussed with respect to FIG. 4). After the AXI signals 412 from the PADB 402 are passed to the ADB1 404, at 704, the AXI signals 412 may be passed to a signal separator of ADB1 404 to separate the read channel signals (e.g., read address signals and read data signals) and the write channel signals (e.g., the write address signals, write data signals, and write response signals). The read address channel (e.g., read address channel 612 of FIG. 6A) in the ADB1 404 may include, for example, ten different signals in which the “araddr [31:0]” bus carries the address information (e.g., see FIG. 6B). For a successful transmission of the address data in the read address channel 612 of the ADB1 404, the “arvalid” and “arready” signals must be logic high to confirm the handshaking process. As such, at 706, at 706, it is determined that if the “arvalid” and “arready” signals of the read address channel are logic high. If the “arvalid” and “arready” signals are logic high in the read address channel 612 of the ADB1 404, at 708, a filter of the anomaly detection system 400 may verify a handshaking process (e.g., to establish communications between components of the SoC) of the read address signal and the read data signal. Handshaking is a mechanism that ensures correct data transfer between components by using a set of signals to indicate the readiness and completion of data transfer. In AXI protocol the ready and valid signal must be high to ensure a successful handshaking. For example, in one or more embodiments, the read address signal and the read data signal handshaking process is analyzed by the anomaly detection system 400. Hand shaking is a process that happens in both read address and the read data channels. During this stage all the possible hand shaking anomalies that can happen in the AXI protocol may be analyzed. For example, handshaking involves the exchange of signals between the components to confirm the readiness of each component to receive or send data. The handshaking signals in the AXI protocol include the “valid” signal, the “ready” signal, and the “acknowledge” signal. These signals ensure that data is transferred at the appropriate time, without overloading the components or causing data loss. Handshaking in the AXI protocol helps ensure data integrity and efficient communication between components.

At 710, the verified signals (e.g., the verified read data signals and read address signals) are further passed to a normalization block of the ADB1 404 for data normalization by converting all the input data or signals values (e.g., the read data signals and read address signals) into real-valued signals between 0 and 1. At 712, the normalized signals (e.g., the read data signals and read address signals) are read. At 714, the normalized read address signals may be further passed to an ANN in the ADB1 404 (e.g., ANN 500 of FIG. 5A), which may forward propagate the signal through the ANN 500 to generate an output (e.g., the construction and the operation of the ANN 500 is discussed with respect to FIGS. 5A-5G). For example, at 716, the anomaly detection system 400 may determine an error threshold for determining an anomaly in the read address signals based on the output signal from the neural network (e.g., ANN 500). At 718, the anomaly detection system 400 may determine or categorize the input signal (e.g., the read address signals) to the ANN 500 of ADB1 404 either as an anomaly or as a positive signal (e.g., a signal with no anomaly). At 718, if the signal is classified as an anomaly, at 720, the time of occurrence along with the signal information may be displayed in a display screen to the user. Otherwise, the anomaly detection system 400 moves to read the signal from the next time stamp and the steps from 712 to 718 are repeated.

After the normalized signals (e.g., the read data signals and read address signals) are read at 712, at 722, the normalized read data signals may be passed to a data signal generator of the ADB1 402, which may predict the “rdata[127:0]”, “rid[5:0]” and “rlast” values in the read data channel (e.g., read data channel 614 of FIGS. 6A-6B). In one or more embodiments, the signal generator may not actually predict the “rdata[127:0]” values, however, such data signal generator may be configured to match the pattern of occurrence. For example, an example data signal generator may be configured to check for the number of bits with matching “rid[5:0]” values, occurrence of “rlast” at the last beat of the transaction etc. At 726, these predicted signals may be compared with the actual read data signals 724 obtained from the signal separator at 704. Based on the result of comparison of the predicted read data signals and the actual read data signals at 726, at 728, if a signal is classified as an anomaly, at 730, the timestamp of occurrence along with the reason and suggestions to correct the anomalous signal is displayed at a display screen corresponding to the ADB1 404. Otherwise, the anomaly detection system 400 may repeat the steps from 724 to 728 to determine anomaly in the read data signal from the next time stamp.

FIG. 7B illustrates a flow diagram for anomaly detection in the write channel signals of the AXI signals, according to one or more embodiments of the present disclosure.

For example, after at 704, the signal separator separates the AXI signals 412 into the read channel signals (e.g., read address signals and read data signals) and the write channel signals (e.g., the write address signals, write data signals, and write response signals), the write channel signals (e.g., the write address signals, write data signals, and write response signals) at 732.

At 734, B-response signals may be analyzed. Because the B-response signals can indicate, whether the write transaction is successful or not, analyzing the B-response signals may provide the anomaly detection system 400 with a first-hand information before debugging the signals further. For example, The B-Resp signal may used to indicate the status of a transaction, specifically the transfer of a single data bit (a basic unit of data transfer) from the slave to the master. The B-Resp signal has several possible values, including “OKAY” to indicate successful completion of the transaction, “EXOKAY” to indicate an exceptional completion of the transaction, and “SLVERR” to indicate a slave error. By sending the B-Resp signal, the slave informs the master about the status of the transaction, allowing the master to determine whether to continue with the next transfer or to handle any errors that may have occurred. For example, in the AXI protocol, the B-response signal is used by the secondary component (e.g., the ADB1 404) to indicate the status of a data transfer. The B-response signal is typically used in response to a write transaction, and it is driven by the secondary component (e.g., the ADB1 404) to indicate whether the write transaction was accepted or not.

At 738, ADB1 404 of the anomaly detection system 400 may determine if there is an anomaly in the write channel signals based on the result of analyzing the B-response signals. If at 738, an anomaly is identified based on analyzing the B-response signals, at 740 and 742, the time of occurrence along with suggestions to fix the anomaly may be displayed on a display screen.

After analyzing the B-response signals at 734, at 736, the write address and write data signal handshaking process is analyzed by the anomaly detection system 400. Hand shaking is an important process that happens in both write address and write data channels. During this stage all the possible hand shaking anomalies that can happen in the AXI protocol may be analyzed. For example, hand shaking process should happen only for one cycle for one “awid[5:0]” value. Cases with hand shaking for multiple cycles are further analyzed for anomaly. As another example, because “awvalid” and “awready” should be asserted/high at least once for one “awid[5:0]” value, if this does not happen, the write channel signals may be analyzed for possible hand shaking anomalies. As another example, if the “Bready” signal is never asserted by the secondary system (e.g., the subordinate 604), waiting for the primary signal, etc., the write channel signals may be analyzed for possible hand shaking anomalies.

At 736, the write channels signals are also separated in the write address signals and write data signal. At 744, the write address signals are transferred to a filter block of the anomaly detection system 400. At 746, the filter block of the anomaly detection system 400 may filter out write address signals with valid handshakes. At 748, the filtered signals (e.g., the write address signals with valid handshakes) are further passed to a normalization block of the anomaly detection system 400 for data normalization by converting all signal values between 0 and 1. At 750, the normalized signals (e.g., the write address signals with valid handshakes) are read. At 752, the normalized write address signals may be further passed to an ANN (e.g., a multi-layer perceptron neural network) in the ADB1 404 (e.g., ANN 502 of FIG. 5H), which may forward propagate the signal into the ANN 502 to generate an output (e.g., the construction and the operation of the ANN 502 is discussed with respect to FIGS. 5H-5I). For example, at 754, the anomaly detection system 400 may determine an error threshold for determining an anomaly in the write address signals based on the output signal from the neural network (e.g., ANN 502). At 756, the anomaly detection system 400 may determine or categorize the input signal to the ANN 502 of ADB1 (e.g., the write address signals) either as an anomaly or as a positive signal (e.g., a signals with no anomaly). At 756, if the signal is classified as an anomaly, at 758, the time of occurrence along with the signal information may be displayed on a display screen to the user and at 760, suggestions to fix the anomaly may be provided. Otherwise, the anomaly detection system 400 moves to read the signal from the next time stamp and the steps from 750 to 756 are repeated.

After the normalized signals (e.g., the write data signals and the write address signals) are read at 750, at 762, the write data signals may be generated using the write address signals. At 766, the generated write data signals may be compared with the actual write data signals from 764 obtained from the signal separator at 736. Based on the result of comparison of the generated write data signals and the actual write data signals at 766, at 768, if a signal is classified as an anomaly, at 770, the timestamp of occurrence along with the reason and suggestions to correct the anomalous signal is displayed at a display screen. At 760, suggestions to fix the anomaly may be provided. Otherwise, the anomaly detection system 400 moves to read the signal from the next time stamp and the steps from 764 to 786 are repeated.

The AI/ML based anomaly detection system of the present disclosure may identify anomalies across all the transactions happening during the SoC development. In some experimental implementations, the anomaly detection system according to the present disclosure identifies anomalies in the AXI protocol with nearly 100% accuracy, and approaches according to the present disclosure are applicable to other protocols. Moreover, the anomaly detection system according to the present disclosure aids the SoC development process by identifying problematic or anomalous transactions from among millions of transactions, thereby alerting developers of the SoC to potential errors in the design. Therefore, the anomaly detection systems of the present disclosure significantly reduce the SoC verification and development time and effort.

FIG. 8 illustrates an example set of processes 800 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 810 with information supplied by a designer, information which is transformed to create an article of manufacture that uses a set of EDA processes 812. When the design is finalized, the design is taped-out 834, which is when artwork (e.g., geometric patterns) for the integrated circuit is sent to a fabrication facility to manufacture the mask set, which is then used to manufacture the integrated circuit. After tape-out, a semiconductor die is fabricated 836 and packaging and assembly processes 838 are performed to produce the finished integrated circuit 840.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 8. The processes described by be enabled by EDA products (or EDA systems).

During system design 814, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 816, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification. For example, the SoC 100 of FIG. 1 may be used in simulation and emulation to automatically identify the time of occurrence of a failure or anomaly with respect to a communication protocol between components of an SoC.

During synthesis and design for test 818, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 820, the netlist is checked for compliance with timing constraints and for correspondence with the HDL code. During design planning 822, an overall floor plan for the integrated circuit is constructed and analyzed for timing and top-level routing.

During layout or physical implementation 824, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 826, the circuit function is verified at the layout level, which permits refinement of the layout design. During physical verification 828, the layout design is checked to ensure that manufacturing constraints are correct, such as DRC constraints, electrical constraints, lithographic constraints, and that circuitry function matches the HDL design specification. During resolution enhancement 830, the geometry of the layout is transformed to improve how the circuit design is manufactured.

During tape-out, data is created to be used (after lithographic enhancements are applied if appropriate) for production of lithography masks. During mask data preparation 832, the ‘tape-out’ data is used to produce lithography masks that are used to produce finished integrated circuits.

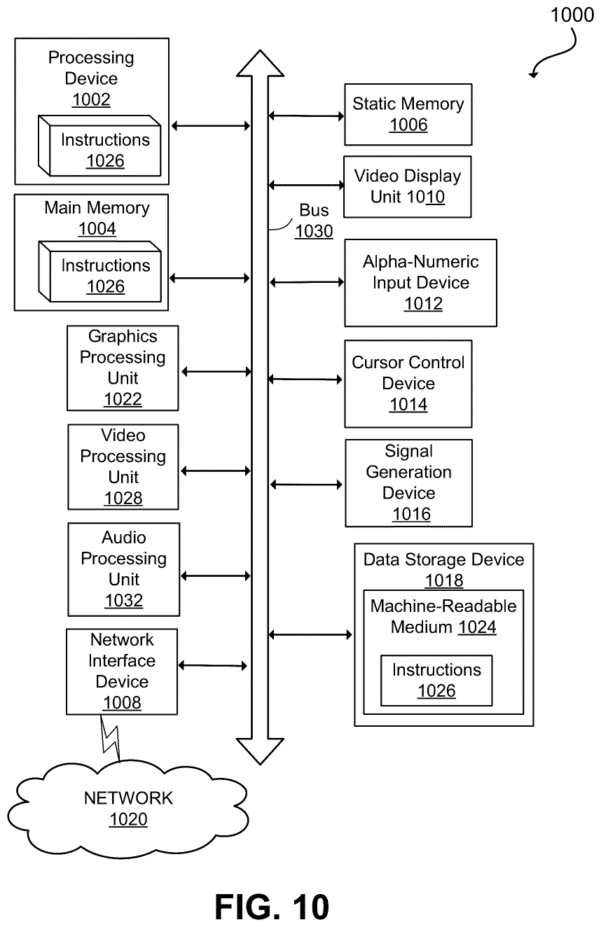

A storage subsystem of a computer system (such as computer system 1000 of FIG. 10, or host system 907 of FIG. 9) may be used to store the programs and data structures that are used by some or all of the EDA products described herein, and products used for development of cells for the library and for physical and logical design that use the library.

FIG. 9 depicts a diagram of an example emulation environment 900. An emulation environment 900 may be configured to verify the functionality of the circuit design. The emulation environment 900 may include a host system 907 (e.g., a computer that is part of an EDA system) and an emulation system 902 (e.g., a set of programmable devices such as Field Programmable Gate Arrays (FPGAs) or processors). The host system generates data and information by using a compiler 910 to structure the emulation system to emulate a circuit design. A circuit design to be emulated is also referred to as a Design Under Test (‘DUT’) where data and information from the emulation are used to verify the functionality of the DUT.

The host system 907 may include one or more processors. In the embodiment where the host system includes multiple processors, the functions described herein as being performed by the host system can be distributed among the multiple processors. The host system 907 may include a compiler 910 to transform specifications written in a description language that represents a DUT and to produce data (e.g., binary data) and information that is used to structure the emulation system 902 to emulate the DUT. The compiler 910 can transform, change, restructure, add new functions to, and/or control the timing of the DUT.

The host system 907 and emulation system 902 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 907 and emulation system 902 can exchange data and information through a third device such as a network server.

The emulation system 902 includes multiple FPGAs (or other modules) such as FPGAs 904₁ and 904₂ as well as additional FPGAs to 904_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 902 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 904₁-904_{N} may be placed onto one or more boards 912₁ and 912₂ as well as additional boards through 912_{M}. Multiple boards can be placed into an emulation unit 914₁. The boards within an emulation unit can be connected using the backplane of the emulation unit or any other types of connections. In addition, multiple emulation units (e.g., 914₁ and 914₂ through 914_{K}) can be connected to each other by cables or any other means to form a multi-emulation unit system.

For a DUT that is to be emulated, the host system 907 transmits one or more bit files to the emulation system 902. The bit files may specify a description of the DUT and may further specify partitions of the DUT created by the host system 907 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 907 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 907 and/or the compiler 910 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 905 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, which may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. An anomaly detection system comprising:
a primary processing device configured to receive one or more input signals from a simulated system on chip (SoC) circuit electrically coupled to the primary processing device and to classify the one or more input signals based on respective communication protocols of the one or more input signals; and
a plurality of secondary processing devices communicatively coupled to the primary processing device, a secondary processing device from among the plurality of secondary processing devices being configured to receive signals from among the classified one or more input signals from the primary processing device, and to determine one or more anomalies in the received signals, the received signals having a communication protocol corresponding to the secondary processing device.

2. The anomaly detection system of claim 1, wherein the communication protocols comprise an Advanced extensible Interface (AXI4) protocol, a Peripheral Component Interconnect Express (PCIe) protocol, a Display Serial Interface (DSI) Physical Layer (PHY) (DPHY) protocol, an Advanced Peripheral Bus (APB) protocol, a Universal Serial Bus (USB) protocol, an embedded Multi-Media Card (eMMC) protocol, and a Universal Asynchronous Receiver/Transmitter (UART) protocol.

3. The anomaly detection system of claim 1, wherein the primary processing device is configured to select the secondary processing device from among the plurality of secondary processing devices based on one or more characteristics of the secondary processing device.

4. The anomaly detection system of claim 1, wherein the primary processing device comprises one or more artificial neural networks (ANNs) to perform the classification of the one or more input signals based on the respective communication protocols of the one or more input signals.

5. The anomaly detection system of claim 4, wherein the one or more ANNs of the primary processing device comprise a multi-layer perceptron neural network configured to classify the one or more input signals based on the respective communication protocols and to assign the secondary processing device from among the plurality of secondary processing devices to detect anomalies.

6. The anomaly detection system of claim 1, wherein each of the plurality of secondary processing devices comprises one or more artificial neural networks (ANNs) configured to determine the one or more anomalies in the received signals having the communication protocol corresponding to the secondary processing device.

7. The anomaly detection system of claim 6, wherein a structure of the one or more ANNs, in each of the plurality of secondary processing devices is based on the communication protocol of the received signals.

8. The anomaly detection system of claim 1, wherein the primary processing device is further configured to receive results of the determining the one or more anomalies from each of the plurality of secondary processing devices and to generate a report comprising the results.

9. The anomaly detection system of claim 1, wherein the secondary processing device is further configured to determine a time of occurrence of the one or more anomalies in the one or more input signals having the communication protocol corresponding to the secondary processing device and to provide suggestions to fix the one or more anomalies.

10. A method comprising:
receiving, at a primary processing device, one or more input signals from a simulated system on a chip (SoC) circuit connected to the primary processing device;
classifying, by the primary processing device, the one or more input signals based on respective communication protocols of the one or more input signals; and
receiving, by a secondary processing device from among a plurality of secondary processing devices communicatively couple to the primary processing device, signals from among the classified one or more input signals from the primary processing device, the received signals having a communication protocol corresponding to the secondary processing device; and
determining, by the secondary processing device, one or more anomalies in the received signals.

11. The method of claim 10, wherein the determining the one or more anomalies further comprises:
separating, by the secondary processing device, read channel signals and write channel signals from among the received signals having the communication protocol corresponding to the secondary processing device;
verifying, by the secondary processing device, one or more signals from among the read channel signals;
normalizing, by the secondary processing device, the verified one or more signals from among the read channel signals; and
determining, by the secondary processing device, one or more anomalies in the one or more signals from among the read channel signals.

12. The method of claim 11, wherein the one or more anomalies in the one or more signals from among the read channel signals are determined by one or more artificial neural networks (ANNs) of the secondary processing device, wherein the one or more signals from among the read channel signals comprise read address signals, and wherein the determining the one or more anomalies further comprises:
processing, by the one or more ANNs of the secondary processing device, the read address signals;
determining, by the one or more ANNs of the secondary processing device, an error threshold based on an output of the processing the read address signals; and
determining, by the one or more ANNs of the secondary processing device, one or more anomalies in the read address signals based on the error threshold.

13. The method of claim 11, further comprising:
generating, by the secondary processing device, a predicted value of read data signals from among the read channel signals;
comparing, by the secondary processing device, the predicted value of the read data signals with actual values of the read data signals from the received signals having the communication protocol corresponding to the secondary processing device; and
determining, by the secondary processing device, one or more anomalies in the read data signals based on a result of the comparing the predicted value of the read data signals with the actual values of the read data signals.

14. The method of claim 11, further comprising:
analyzing, by the secondary processing device, B-response signals from among the write channel signals;
determining, by the secondary processing device, one or more anomalies in the write channel signals based on a result of analyzing the B-response signals; and
displaying, by a display screen coupled to the secondary processing device, a time of occurrence of the one or more anomalies and suggestions to fix the one or more anomalies.

15. The method of claim 14, wherein the one or more signals from among the write channel signals comprise write address signals, and wherein the determining the one or more anomalies in the write channel signals further comprises:
processing, by one or more artificial neural networks (ANNs) of the secondary processing device, the write address signals;
determining, by the one or more ANNs of the secondary processing device, an error threshold based on an output of the processing the write address signals; and
determining, by the one or more ANNs of the secondary processing device, one or more anomalies in the write address signals based on the error threshold.

16. The method of claim 15, further comprising:
generating, by the secondary processing device, write data signals using the write address signals;
comparing, by the secondary processing device, the generated write data signals with actual write data signals from the one or more input signals having the communication protocol corresponding to the secondary processing device; and
determining, by the secondary processing device, one or more anomalies in the write data signals based on a result of the comparing the generated write data signals with the actual write data signals.

17. A non-transitory computer readable medium comprising stored instructions, which when executed by a processor, cause the processor to:
receive one or more input signals from a simulated system on a chip (SoC) circuit connected to the processor;
classify, using a multi-layer perceptron neural network of the processor, the one or more input signals based on respective communication protocols of the one or more input signals; and
determine, using an artificial neural network (ANN) from among a plurality of ANNs of the processor, one or more anomalies in the one or more input signals corresponding to a communication protocol of the ANN, based on an error threshold.

18. The non-transitory computer readable medium of claim 17, wherein the processor is further configured to:
separate read channel signals and write channel signals from among the one or more input signals corresponding to the communication protocol of the ANN;
verify one or more signals from among the read channel signals;
normalize the verified one or more signals from among the read channel signals; and
determine one or more anomalies in the one or more signals from among the read channel signals.

19. The non-transitory computer readable medium of claim 18, wherein the one or more signals from among the read channel signals comprise read address signals, and wherein to determine the one or more anomalies, the processor is further configured to:
process the read address signals;
determine the error threshold based on an output of the processing the read address signals; and
determine one or more anomalies in the read address signals based on the error threshold.

20. The non-transitory computer readable medium of claim 19, wherein the processor is further configured to:
generate a predicted value of read data signals from among the read channel signals;
compare the predicted value of the read data signals with actual values of the read data signals from the one or more input signals corresponding to the respective communication protocols of the one or more input signals; and
determine one or more anomalies in the read data signals based on a result of the comparison between the predicted value of the read data signals with the actual values of the read data signals.
